(19) United States
(12) Patent Application Publication
(10) Pub. No.: US 2006/0242101 A1
(43) Pub. Date: Oct. 26, 2006

(54) Method and system for semantic matching of Web Service policies

(76) Inventors: Rama Akkiraju, Yorktown Heights, NY (US); Kunal Verma, Athens, GA (US); Richard T. Goodwin, Dobbs Ferry, NY (US)

Correspondence Address: MCGINN INTELLECTUAL PROPERTY LAW GROUP, PLLC, 8321 OLD COURTHOUSE ROAD, SUITE 200, VIENNA, VA, 22182-3817, US

(21) Appl. No.: 11/110,928

(22) Filed: Apr. 21, 2005

(51) Int. Cl. G06F 17/30

(52) U.S. Cl. 707/1

(57) ABSTRACT

A system for and method of matching of web service policies, which includes matching of non-functional properties of first and second Web Services while considering inter-domain interactions of the first and second Web Services using semantics. Methods for semantic matching of web service policies are also described.

### BACKGROUND OF THE INVENTION

1. Field of the Invention

The present invention generally relates to a method and apparatus for matching of non-functional properties of Web Services while considering inter-domain interactions using semantics, and more particularly, for matching of Web Service policies, including matching of non-functional properties of request and advertisement (e.g., first and second) Web Services while considering inter-domain interactions of the request and advertisement (e.g., first and second) Web Services using semantics, and more particularly, for matching the non-functional properties of software applications represented as Web Services while considering inter-domain interactions of the request and advertisement (e.g., first and second) Web Services using semantics.

2. Description of the Related Art

Web Services provide a standards-based framework for exchanging information dynamically between software applications. For example, Web Services Policy Framework (“WS-Policy”) is a general purpose framework for describing capabilities and requirements of web service entities. Each policy is a collection of policy statements. To determine if a web service is suitable for a particular use, the policy requirements of the entity invoking the web service must be compatible with the policies of the entity providing the web service.

To date, most policy matching has been done using a syntactic approach, where pairs of policy statements are compared for structural and syntactic similarity to determine compatibility.

While Web Services capture information about the interface and how to invoke a service, they lack the semantic expressivity required to capture the context and intent of a service.

Recently, Semantic Web Services have stepped in to fill in this gap. By capturing the intent of Web services in machine interpretable languages, Semantic Web Services, enable automated Web Service discovery, composition and execution. Research is underway to investigate the application of semantics to service discovery, composition and monitoring using the functional properties of services such as inputs, outputs, preconditions and effects.

By capturing the intent of Web services in machine interpretable languages, Semantic Web Services, enable automated Web Service discovery, composition and execution. Research is underway to investigate the application of semantics to service discovery, composition and monitoring using the functional properties of services such as inputs, outputs, preconditions and effects.

However, semantic matching of non-functional criteria such as Quality of Service (QoS), security, privacy and transactional capabilities, which plays a significant role in service selection, has not been adequately addressed by the related art.

Current attempts at improving Web Service policy matching either have been based on syntactic models or on a single domain, such as security (for example, see Eric Wohlstadter, Stefan Tai, Thomas Mikalsen, Isabelle Rouvello, and Premkumar Devanbu, “GlueQoS: Middleware to Sweeten Quality-of-Service Policy Interactions,” http://www.cs.ucdavis.edu/˜devanbu/icse2004-gq.pdf, see also Nirmal K Mukhi and Pierluigi Plebani, Supporting Policy-driven behaviors in Web Services:Experiences and Issues, To appear in the proceedings of the International Conference on Services Oriented Computing (ICSOC), 2004; see also Lalana Kagal, Massimo Paoucci, Naveen Srinivasan, Grit Denker, Tim Finin, and Katia Sycara, “Authorization and Privacy for Semantic Web Services,” http://ebiquity.umbc.edu/v2.1/_file_directory_/papers/84.pdf).

However, syntactic models do not capture the context and the domain knowledge. Therefore, the syntactic models are limited in their ability to support dynamic discovery.

Lei Li and Ian Horrocks, “A Software Framework For Matchmaking Based on Semantic Web Technology,” http://www.cs.man.ac.uk/˜lil/papers/ijec.pdf provides an approach for matching non-functional attributes using some notion of semantics. However, the framework is restricted because this method relies solely on subsumption for matching. Also, this method does not accommodate rules for capturing business policies.

Moreover, considering “subsumption” alone is not sufficient for matching policies, as it is possible for policies to be equivalent or related by other relationships such as ‘part of’.

### SUMMARY OF THE INVENTION

In view of the foregoing and other exemplary problems, drawbacks, and disadvantages of the conventional methods and structures, an exemplary feature of the present invention is to provide a method and apparatus for matching of non-functional properties while considering inter-domain interactions using semantics, and more particularly, for matching of web service policies, including matching of non-functional properties of request and advertisement (e.g., first and second) Web Services while considering inter-domain interactions of the request and advertisement (e.g., first and second) Web Services using semantics, and more particularly, for matching the non-functional properties of software applications represented as Web Services while considering inter-domain interactions of the request and advertisement (e.g., first and second) Web Services using semantics.

The exemplary aspects of the present invention provide a novel and unobvious approach for matching the non-functional properties of software applications represented as Web Services. For example, some of the exemplary aspects of the present invention represent the non-functional properties of Web Services in multiple domains such as security, transactional, business, etc., as declarative policies using semantic domain models and rules.

As mentioned above, for purposes of the present application, domain models are used to represent the concepts/terms and their relationships in a domain, and business rules are used to infer new pieces of knowledge, which can lead to better matching. According to the exemplary aspects of the present invention, the matching framework is able to match policies by applying the rules and inferencing on the relationships between the terms defined in the domain models. This novel aspect of the present invention results in matches that may not have been possible with syntax based matchers alone.

The present invention is domain independent and can handle domains like trust and privacy. In addition, the present invention is capable of incorporating numerical reasoning into the system.

While the present invention also takes care of hierarchical relationships (the basis for subsumption), it is more flexible. That is, the present invention can use subsumption based reasoning, as well as specialized domain reasoners for the matching. In addition, the present invention can support relationships (inter and intra domain) which cannot be represented using description logics by using rules.

To summarize, the exemplary aspects of the present invention provide a system and method for matching non-functional requirements of Web services based on creating rich domain models using ontologies and rules. Thus, the present invention can provide a domain independent approach for semantic policy matchmaking as well as an approach for implementing horn logic-based rules to be used in conjunction with OWL based ontologies. Horn logic based rules are rules of the form antecedent [symbol] consequent, where antecedent and consequents consist of conjunction of atoms. If the antecedent is true, then the consequent preferably also holds.

### BRIEF DESCRIPTION OF THE DRAWINGS

The foregoing and other exemplary purposes, aspects and advantages will be better understood from the following detailed description of an exemplary embodiment of the invention with reference to the drawings, in which:

FIG. 1 illustrates an exemplary system 100 for matching of non-functional properties according to the present invention;

FIG. 2 illustrates an exemplary method 200 of matching of non-functional properties according to the present invention;

FIG. 3 illustrates an exemplary representation 300 of WS Security;

FIG. 4 illustrates a Table 400 of example rules and domain knowledge for matching, according to an exemplary aspect of the present invention;

FIG. 5 illustrates an exemplary graphical representation 500 of a Policy P1 according to the present invention;

FIG. 6 illustrates an exemplary graphical representation 600 of a Policy P1′ to be matched according to the present invention;

FIG. 7 illustrates an exemplary graphical representation 700 of a Policy P2 according to the present invention;

FIG. 8 illustrates an exemplary graphical representation 800 of a Policy P2′ according to the present invention;

FIG. 9 illustrates an exemplary hardware/information handling system 900 for incorporating the present invention therein;

FIG. 10 illustrates a signal bearing medium 1000 (e.g., storage medium) for storing steps of a program of a method according to the present invention; and

FIG. 11 illustrates an exemplary RAID array 1100 (e.g., storage medium) for storing steps of a program of a method according to the present invention.

### DETAILED DESCRIPTION OF EXEMPLARY EMBODIMENTS OF THE INVENTION

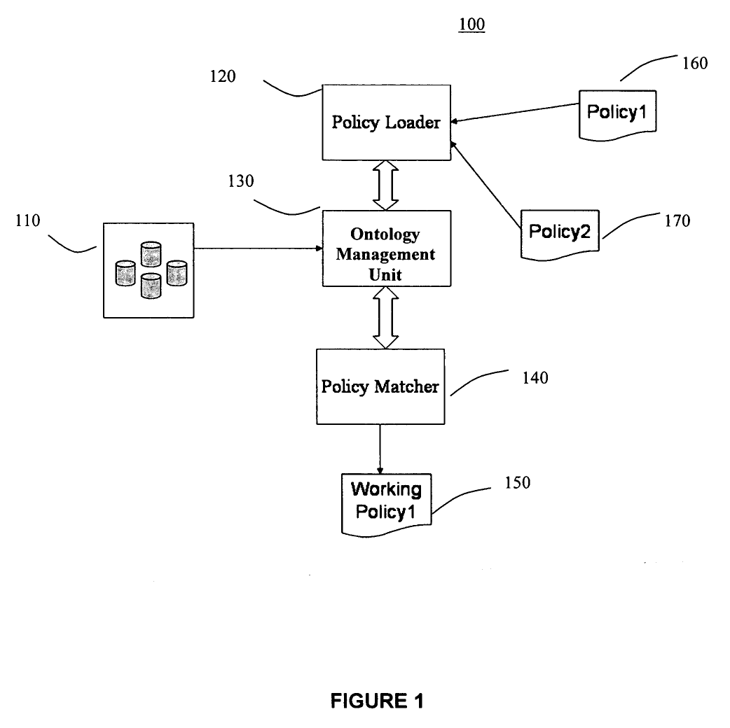

Referring now to the drawings, and more particularly to FIGS. 1-11, there are shown exemplary embodiments of the method and structures according to the present invention.

The unique and unobvious features of the present invention are directed to a novel system and method for matching of non-functional properties while considering inter-domain interactions using semantics, and more particularly, for matching the non-functional properties of software applications represented as Web Services while considering inter-domain interactions using semantics.

### Exemplary Embodiment

Prior to discussing the exemplary embodiment, some terminology will be defined for purposes of the present invention.

Domain models or Ontologies generally are used to represent the concepts/terms and their relationships in a domain.

Business rules generally are used to infer new pieces of knowledge, which can lead to better matching.

Policy generally is defined as a collection (or set) of alternatives.

An alternative generally is defined as a collection of assertions.

An assertion generally is used to represent a requirement, capability, or a behavior, etc., of a Web service. An assertion can have, for example, an arbitrary number of child assertions and attributes.

An assertion type is an attribute that is used to specify whether an assertion is a requirement or a capability.

A value type is an attribute that is used to specify whether an assertion is a numeric or a non-numeric assertion.

A comparison operator is an attribute that is used to represent the relationship between the assertion name and value.

As mentioned above, by capturing the intent of Web Services in machine interpretable languages, Semantic Web Services, enable automated Web Service discovery, composition and execution. Research is underway to investigate the application of semantics to service discovery, composition and monitoring using the functional properties of services such as inputs, outputs, preconditions and effects.

However, semantic matching of non-functional criteria such as Quality of Service (QoS), security, privacy and transactional capabilities, which plays a significant role in service selection, has not been adequately addressed by the related art. The exemplary aspects of the present invention provide a novel approach to matching Web Service policies.

As mentioned above, current attempts at improving Web Service policy matching either have been based on syntactic models or on a single domain, such as security (for example, see GlueQoS, Mukhi, and Plebani). However, syntactic models do not capture the context and the domain knowledge, and are limited in their ability to support dynamic discovery.

Creating rich domain models of non-functional attributes, and frameworks for matching policies that can reason on these models, according to the exemplary aspects of the present invention, provides advantages over the related art, for better supporting automatic discovery. Also, matching of policies in other domains such as transactions, quality of service, etc., according to the exemplary aspects of the present invention, also provides advantages over the related art.

As mentioned above, Lei Li and Ian Horrocks provides an approach in which the framework is restricted because the method relies solely on subsumption for matching, and also does not accommodate rules for capturing business policies. Moreover, as mentioned above, considering “subsumption” alone is not sufficient for matching policies, as it is possible for policies to be equivalent or related by other relationships such as ‘part of’.

In fact, in contrast to the related art, the exemplary aspects of the present invention have the advantage of treating policy matching as a bidirectional matching problem, where each policy's requirements preferably are satisfied by the other policy's capabilities, and vice versa.

In addition, the present invention advantageously has identified (and thus, has implemented this feature into an exemplary aspect of the invention), that support for capturing business rules, which often can create new knowledge, is one of many helpful (e.g., beneficial, important, etc.) components of policy matching. The novel and unobvious features of the present invention, or the advantages provided by such features, have not been considered by the related art, such as Li and Horrocks.

Hence, the exemplary aspects of the present invention provide a novel and unobvious approach for matching the non-functional properties of software applications represented as Web Services. For example, some of the exemplary aspects of the present invention represent the non-functional properties of Web Services in multiple domains such as security, transactional, business, etc., as declarative policies using semantic domain models and rules.

As mentioned above, for purposes of the present application, domain models are used to represent the concepts/terms and their relationships in a domain, and business rules are used to infer new pieces of knowledge, which has the advantage of providing better matching. For example, according to the exemplary aspects of the present invention, the matching framework is able to match policies by applying the rules and inferencing on the relationships between the terms defined in the domain models. This novel aspect of the present invention provides the advantage of providing matches that would not have been possible with syntax based matchers alone.

The following examples illustrate how semantics based policy matching works, according to the exemplary aspects of the present invention.

As a first example, a provider may assert that it requires some form of encryption for the interaction. On the other hand, a requestor may assert that it can only interact using the 3DEC encryption algorithm. The security domain model according to an exemplary aspect of the present invention can capture information that a 3DEC encryption algorithm is a ‘type of’ encryption algorithm.

Thus, the exemplary matcher according to the present invention can use the security domain model to infer this type of relationship and conclude that there is a match between the policy of the provider and the policy of the requester.

As a second example, a provider may assert that it can provide a Response Time of 40 seconds and Network Time of 10 seconds. On the other hand, a requestor may require a Processing Time of 60 seconds.

Thus, based on a domain rule which states that ‘Total Time=Network Time+Response Time’, and the ontology assertion that total time is the same as processing time, the exemplary matcher can match these assertions.

As a third example, a provider may only want to deal with enterprise level businesses. Thus, the domain model can contain rules that define enterprise level businesses as having a certain size rating on Dun and Bradstreet (D&B rating) or being on the Fortune 500 list. On the other hand, a requester may assert that their D&B rating is A, or that they are a Fortune 500 company.

Thus, the exemplary matcher can infer that the requestor is an enterprise level business based on the application of the business rule.

There are numerous advantages of the approach according to the exemplary aspects of the present invention.

First, the use of domain models and rules allows for richer representations of the context in which policies are defined. These richer representations are captured in machine interpretable and inferencable semantic markup languages such as OWL (Ontology Web Language), Unified Modeling Language UML+Object Constraint Language (OCL), etc. This allows for automatic matching of policies while considering the context in which they operate.

Second, according to the present invention, rules can be used to handle inter-domain interactions.

For example, requiring encryption using algorithm A while at the same time requiring message compression using algorithm B may not be technically achievable (e.g., see Mukhi and Plebani). However, the domain model for the above exemplary aspect of the present invention is capable of capturing a rule which indicates what types of encryption and compression algorithms are compatible. Thus, according to the present invention, this information can be used in evaluating the policies and validating them.

In summary, the exemplary aspects of the present invention provide advantages over the related art methods.

For example, by using semantic matching and rule evaluation methods, the exemplary aspects of the present invention are capable of matching policies that could not have been matched using syntactic matching alone.

As another example, domain models according to the exemplary aspects of the present invention are capable of capturing the relationships between various terms used in defining the policies. Therefore, policies can be represented more succinctly by referring to the terms in the domain model. This reduces verbosity in defining policies since enumeration of equivalent alternatives or other relationships are now captured in the domain model instead of the policy.

As yet another example, the exemplary aspects of the present invention are capable of handling inter-domain interactions by processing the rules represented in the domain models and identifying any inconsistencies in the policies specified for a Web Service.

According to an exemplary aspect of the present invention, the same notation that is used for WS-Policy specifications can be used for representing policies, according to the present invention.

As mentioned above, for purposes of this disclosure, a “policy” generally is defined as a collection of alternatives, an “alternative” generally is defined as a collection of assertions, and an “assertion” generally is used to represent a requirement, capability, or a behavior (for example, of a Web Service, etc.).

An example of an assertion stating a requirement could be ‘Security Token must be X.509’. An example of an assertion stating a capability would be ‘Response Time <=30 ms’.

The present invention can use, for example, a descriptions logic-based Ontology Web Language (OWL), etc., as the semantic markup language for representing the domain models. The matcher according to the exemplary aspects of the present invention can be built using ontology management systems which are used to store, and query domain models.

The following is a summary of WS Policy and WS-Policy Matching.

WS-Policy provides a grammar for representing the non-functional attributes of entities in a Web Services based XML environment [WS-Policy].

### WS-Policy

In XML, WS-Policy has a number of tags to instantiate the model. The “Policy” tag is used to start and end a policy. The “ExactlyOne” tag is used to contain a set of alternatives and the “All” tag contains all the assertions in an alternative. Each assertion belongs to some vocabulary and have any number of attributes or child assertions.

The following is a sample policy:

01 <wsp:Policy>
02 <wsp:ExactlyOne>
03 <wsp:All>
04 <wsse:SecurityToken>
05 <wsse:TokenType>wsse:Kerberosv5TGT</wsse:TokenType>
06 </wsse:SecurityToken>
07 </wsp:All>
08 <wsp:All>
09 <wsse:SecurityToken>
10 <wsse:TokenType>wsse:X509v3</wsse:TokenType>
11 </wsse:SecurityToken>
12 </wsp:All>
13 </wsp:ExactlyOne>
14 </wsp:Policy>

The above example policy has two alternatives and each alternative has one assertion from the WS-Security vocabulary. The assertion in alternative 1 states that the service requires a security token of type Kerberosv5TGT, while the alternative in the alternative 2 states that the service requires a security token of type X.509 (version 3). Hence, a service or client which wants to interact with the service preferably provides either of the security tokens for a successful interaction.

### Policy Matching

Turning now to policy matching, once a client or a service finds another service with the desired functionality, it preferably evaluates whether it can successfully interact with service by matching the policies. WS-Policy also describes a policy normal form which is seen as a disjunction of alternatives and conjunction of all assertions in an alternative. For purposes of this exemplary description, the normal form for policy matching is used.

A policy P is defined as a finite set of alternatives. It can also be expressed as a disjunction of all its alternatives
P={Alt1, Alt2, . . . AltN}=Alt1|Alt2| . . . AltN

An alternative Alt is defined as a finite set of assertions. It can also be expressed as a conjunction of all its assertions.
Alt={A1, A2 . . . AN}=A1 [symbol] A2 [symbol] . . . AN

Matching two policies is reduced to finding two equivalent alternatives.
((^{∃}Alt1) S.T. Alt1εP1 and (^{∃}Alt2) S.T. Alt2εP2 and Alt1 [symbol] Alt2 [symbol] (P1 [symbol] P2)

Finding equivalent alternatives can be defined in the following manner. Two alternatives are equivalent, if for each assertion in both alternatives, there exists an equivalent assertion.
((^{∀}Aᵢ) S.T. AᵢεAlt1 and (^{∃}Aⱼ) S.T. AⱼεAlt2 and Aᵢ [symbol] Aⱼ) and ((^{∀}Aᵢ) S.T. Aᵢ εAlt2 and (^{¤}Aⱼ) S.T. AⱼεAlt1 and A1 [symbol] A2)) [symbol] (Alt1 [symbol] Alt2)

In the above, exemplary policy framework, equivalent assertions can be computed using syntactical matching of the assertions.

In addition, a working policy preferably is created from the equivalent alternatives. In some cases, the intersection of policies may also be useful to find common properties and creating a limited working policy, which may be used with additional human interaction.

An exemplary WS-Policy specification relies on XML-based vocabularies like WS-Security and WS-Trust to make assertions in those domains. In principle, two parties can make assertions in any number of domains, as long as they have an agreed upon vocabulary. However, if the matching is unaware of the semantics of the assertions, it will be somewhat restricted.

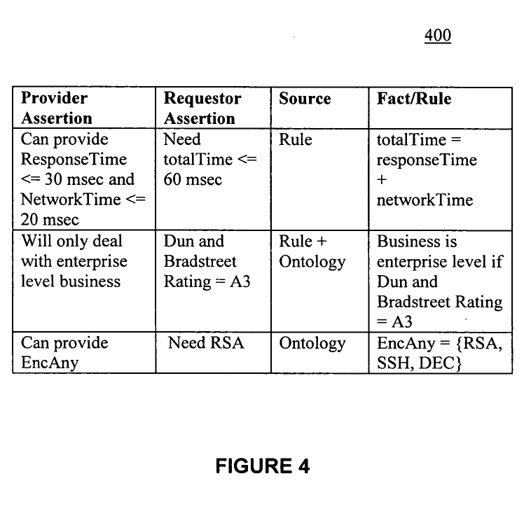

In order to illustrate this point, consider the examples set forth in FIG. 4.

In the example, a provider may assert that it can provide a Response Time of 40 seconds and Network Time of 10 seconds, while the requester may require a Processing Time of 60 seconds. Based on a domain rule which states that ‘Total Time-=Network Time+Response Time’, as well as the ontology assertion that ProcessingTime is the same entity as TotalTime, the matcher can match these assertions.

Moreover, the provider may only want to deal with enterprise level businesses. It can create rules that define enterprise level businesses as having a certain size rating on Dun and Bradstreet (D&B rating) or being on the Fortune 500 list. The requester may assert that their D&B rating is 3A or that they are a Fortune 500 company. The matcher can infer that it is an enterprise level business based on the application of the business rule.

Further, a requestor may assert that it requires some form of encryption (from a given set) for the interaction, and a requestor may assert that it can only interact using the 3DEC encryption algorithm. The security domain model captures information that a 3DEC encryption algorithm is a ‘type of encryption algorithm. The matcher can infer this ‘type of relationship from the domain model and conclude that there is a match between these two policies.

In the above assertions, if syntactic matching were used, the matcher would have no additional knowledge about the domain, and it would only perform string matching on the attributes of the assertions. This would lead to false negatives, even though the assertions are equivalent.

If a domain expert was in the loop, and the expert would have additional information, which is now represented using domain ontologies and rules, then, the expert would be able to state that the above assertions were equivalent. The exemplary aspects of the present invention involves capturing knowledge about the domains in ontologies and rules, and then using the new knowledge that is inferred from the ontology to match assertions.

The architecture of an exemplary system according to the present invention is shown in FIG. 1. The main modules of the exemplary architecture 100 are the policy loader 120, the policy matcher 140 and the ontology reasoner or ontology management unit 130.

### Policy Loader

In the exemplary aspects of the present invention, policies (e.g., Policy1 (i.e., P1, 160) and Policy2 (i.e., P2, 170) in FIG. 1) are stored as instances of policy objects defined, for example, in an OWL file. The exemplary policy loader module 120 loads policies in OWL or XML using the Java® API. The exemplary module 120 is responsible for interacting with the ontology management unit 130, which includes the logics reasoning engines, such as SNOBASE engine, etc., and reasoner for creating of OWL policies.

### Semantic Network Ontology Management System

For reasoning on domain ontologies and rules, an exemplary aspect of the present invention uses a semantic network based ontology management system (e.g., 130) (e.g., see Lee et al., SNoBASE: A Semantic Network-based Ontology Management. http://alphaWorks.ibm.com/tech/snobase. 2003) that offers DQL-based (e.g., see DQL, 2003) Java® API for querying ontologies represented in OWL (e.g., see Bigus et al., ABLE: A toolkit for building multiagent autonomic systems, IBM Systems Journal, Volume 41, Number 3, 2002) engine for inferencing. In order to support rules, the present invention can implement a module for adding, for example, SWRL-based horn logic (http://www.daml.org/2003/11/swrl/) support to logics reasoning engines, such as SNOBASE, etc.

### Policy Matcher

A policy matcher module (e.g., 140) is responsible for matching two policies (e.g., Policy1 (160) and Policy2 (170)). The exemplary policy matcher (e.g., 140) can use the reasoning capabilities of the logics reasoning engines of the ontology management unit 130, as well as a numeric reasoning module for matching two policies (e.g., Policy1 (P1, 160) and Policy2 (P2, 170)) based on an algorithm. The policy matcher (e.g., 140) outputs a working policy (e.g., working Policy1 (150)) as a result of the matching.

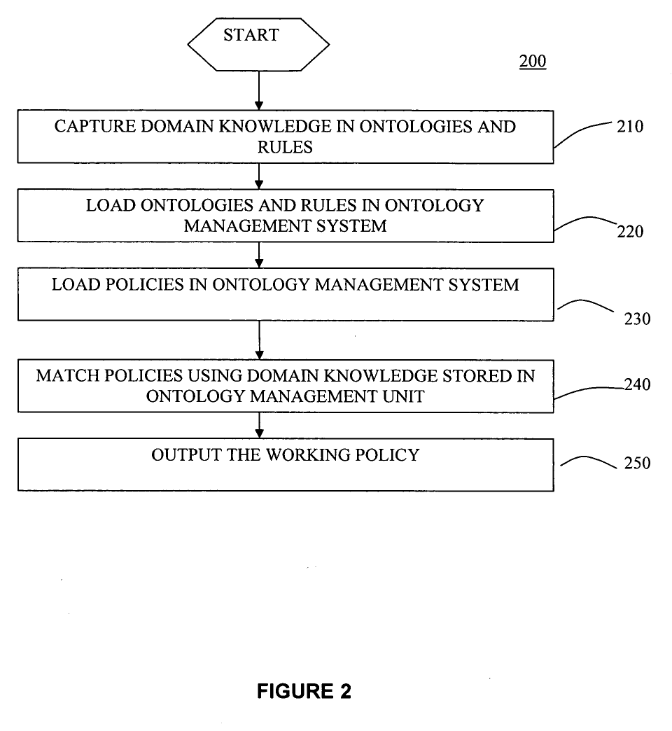

As shown in FIG. 2, the exemplary method 200 of matching includes capturing (e.g., step 210) domain knowledge in ontologies and rules, then loading (e.g., step 220) the ontologies and rules into the ontology management system (e.g., 130 in FIG. 1). The policies (e.g., 160 and 170 in FIG. 1) also are loaded (e.g., step 230) into the ontology management system (e.g., 130). The exemplary method 200 then matches (e.g., step 240) the policies using domain knowledge stored in the ontology management unit (e.g., 130 in FIG. 1) and outputs (e.g., step 250) a working policy (e.g., 150 in FIG. 1).

### Capturing Domain Knowledge in Ontologies and Rules

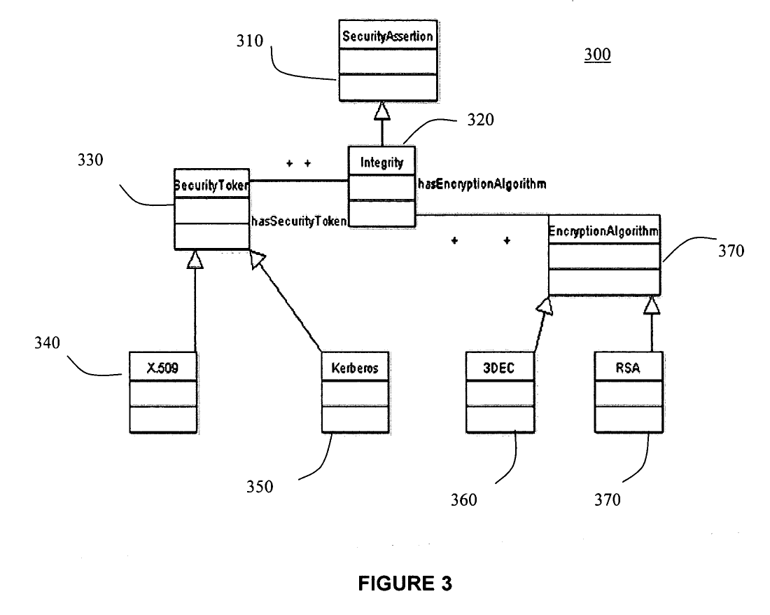

We now turn to capturing (e.g., step 210 in FIG. 2) domain knowledge in ontologies and rules (e.g., 110 in FIG. 1. Knowledge in relevant domains like security and trust are captured using, for example, OWL ontologies. In order to exemplarily illustrate the content of domain ontologies, a UML representation (e.g., 300) based on WS-Security is shown in FIG. 3.

These classes and relationships are captured as OWL classes and properties.

Integrity Assertion (e.g., 320) is a Security Assertion (e.g., 310).

<owl:Class rdf:ID=“IntegrityAssertion”>
<rdfs:subClassOf rdf:resource=“#SecurityAssertion”/>
</owl:Class>

Integrity Assertion (e.g., 320) has two properties, has an Encryption Algorithm (e.g., 370) and has a Security Token (e.g., 330).

<owl:ObjectProperty rdf:ID=“hasEncryptionAlgorithm”>
<rdfs:range rdf:resource=“#EncryptionAlgorithm”/>
<rdfs:domain rdf:resource=“#IntegrityAssertion”/>
</owl:ObjectProperty>
<owl:ObjectProperty rdf:ID=“hasSecurityToken”>
<rdfs:domain rdf:resource=“#IntegrityAssertion”/>
<rdfs:range rdf:resource=“#SecurityToken”/>
</owl:ObjectProperty>

X.509 (e.g., 340) is a security token.

<owl:Class rdf:ID=“X.509”>
<rdfs:subClassOf rdf:resource=“#SecurityToken”/>
</owl:Class>

RSA (e.g., 380) is an encryption Algorithm.

<owl:Class rdf:ID=“RSA”>
<rdfs:subClassOf>
<owl:Class rdf:ID=“EncryptionAlgorithm”/>
</rdfs:subClassOf>
</owl:Class>

IntegrityAssertion_{—}1_X.509V2_RSA is an integrity assertion (e.g., 320) with security token X.509 version 2 (e.g., 340) and encryption algorithm 512 bit RSA (e.g., 380).

<IntegrityAssertion rdf:ID=“IntegrityAssertion_1_X.509V2_RSA”>
<hasSecurityToken>
<X.509 rdf:ID=“X.509v2”>
<version rdf:datatype=“http://www.w3.org/2001/XMLSchema#string”
>v2</version>
</X.509>
</hasSecurityToken>
<hasEncryptionAlgorithm rdf:resource=“#RSA_512”/>
</IntegrityAssertion>
</rdf:RDF>

In order to represent domain knowledge, which cannot be expressed using OWL, the exemplary aspects of the present invention use a SWRL like rules language encoded in a proprietary rule engine (Agent Building and Learning Environment—ABLE). FIG. 4 illustrates a table 400 including examples of some rules. The rules are encoded in a “when do” format. The following are further examples of some rules:

Rule 1:

```
    // if there exists a policy P, which has an alternative ALT, which has
an Assertion A, which states that DunAndBradstreetRating = 3A
    // then create a new Assertion A1 such Business Level A1 is
    Enterprise and it belongs to Alternative Alt
```

when:
Policy (P) and has Alternative (P, ALT) and has Assertion (ALT, A) and DunAndBradstreetRating(A, “3 A”)

do:
Assertion(A1) and Business Level (A1, “Enterprise”) and has Alternative (Alt, A1)

Rule 2:

// if there exists a policy P, which has an alternative ALT, which has
an Assertion A, which states that DunAndBradStreetRating = 2A
// then create a new Assertion A1 such Business Level A1 is Medium and
it belongs to Alternative Alt

when:
Policy (P) and has Alternative (P, ALT) and has Assertion (ALT, A) and DunAndBradstreetSize(A, “2A”)

do:
Assertion (A1) and Business Level (A1, “Medium”) and has Alternative (Alt, A1)

Rule 3:

// if there exists a policy P, which has an alternative ALT, which has
an Assertion A, which states that DunAndBradStreetRating = 1A
// then create a new Assertion A1 such Business Level A1 is Small and
it belongs to Alternative Alt

when:
Policy (P) and has Alternative (P, ALT) and has Assertion (ALT, A) and DunAndBradStreetRating(A, “1 A”)

do:
Assertion (A1) and Business Level (A1, “Small”) and has Alternative (Alt, A1)

Rule 4:

// if there exists a policy P, which has an alternative ALT, which has
an Assertion A1, which states that Response Time = X and Assertion A2,
which states that Network Time
= Y
// then create a new Assertion A3 which states that Total Time = X + Y

when:
Policy (P) and has Alternative (P, ALT) and has Assertion (ALT, A1) and has Assertion (ALT, A2) and Response Time(A1, X) and Network Time (A2, Y)

do:
Assertion (A3) and Total Time (A3, X+Y) and has Alternative (Alt, A3)

Exemplary Rule 1 states that if there exists a policy P, which has an Alternative ATL, which further has an Assertion A, which asserts that Dun and Bradstreet rating of the entity (service provider or client) is “3A”, then that entity is categorized as an “Enterprise” using a new assertion, which is added to that alternative. There are similar rules (Rules 2 and 3) for categorizing businesses as “Medium” and “Small” depending on their Dun and Bradstreet rating. Rule 4 uses the knowledge that Total Time is the sum of Network Time and Response Time to calculate the total time of services.

One of the exemplary purposes for adding rules in the exemplary systems according to the present invention is to infer new facts which will aid in the matchmaking. Once the ontologies and rules are created, they are stored in the ontology management system (step 220), such as SNOBASE, etc.

### Semantic Policy Matching Algorithm

As set forth above, policy P is defined as finite set of alternatives. It can also be expressed as a disjunction of all its alternatives
P={Alt1, Alt2, . . . Alt N}=Alt1|Alt2| . . . Alt N

An alternative Alt is defined as a finite set of assertions. It can also be expressed as a conjunction of all its assertions.
Alt={A1, A2 . . . AN}=A1 [symbol] A2 [symbol] . . . AN

Matching two policies is reduced to finding two equivalent alternatives.
((^{∃}Alt1) S.T. Alt1 εP1 and (^{∃}Alt2) S.T. Alt2εP2 and Alt1 [symbol] Alt2) [symbol] (P1 [symbol] P2)

Equivalent alternatives can be defined as alternatives whose capabilities satisfy each others requirements. In order to write the definition, functions “req” and “cap”, are defined, which represents the requirement and capability assertions of an alternative respectively
((^{∀}A1) S.T. A1εreq (Alt1) and (^{∀}A2) S.T. A2εcap (Alt2) and A1 satisfies A2) and ((^{∀}A1) S.T. A1εreq (Alt2) and (^{∃}A2) S.T. A2εcap(Alt1) and A1 satisfies A2)) [symbol] (Alt1 [symbol] Alt2)

In order to explain the satisfiability of one assertion by another, the following functions are defined.

“val” returns the value of an assertion or an attribute.

“type” returns the type of an assertion or an attribute.

“children” returns all the children of an assertion.

“attributes” returns all attributes of an assertion.

An assertion can have an arbitrary number of child assertions and attributes. For an assertion A2, to satisfy assertion A1, it preferably satisfies the value as well as all the attributes of A1. In addition, its children preferably recursively satisfy, assertion A1's children. This can be expressed as:
[val (a2) satisfies val (A1) and (^{∀}attrᵢ) S.T. attrᵢεattributes(A1) and (^{∃}attrⱼ) S.T. attrⱼεattributes (A2) and type(attrᵢ)=type (attrⱼ) and val (attrⱼ) satisfies val (attrᵢ)) and ((^{∀}child1) S.T. child1εchildren(A1) and (^{∃}child2) S.T. child2εchildren (A2) and child1 satisfies child2)] [symbol] (A2 satisfies A1)

Following operators are used to check value or attribute satisfiability

1. For numeric assertions
=, <, >, <=, >=

2. For non numeric instructions
sameClassAs, samelnstanceAs, subClassOf, instanceOf, superClassOf, subsumes

### Example of Semantic Policy Matching

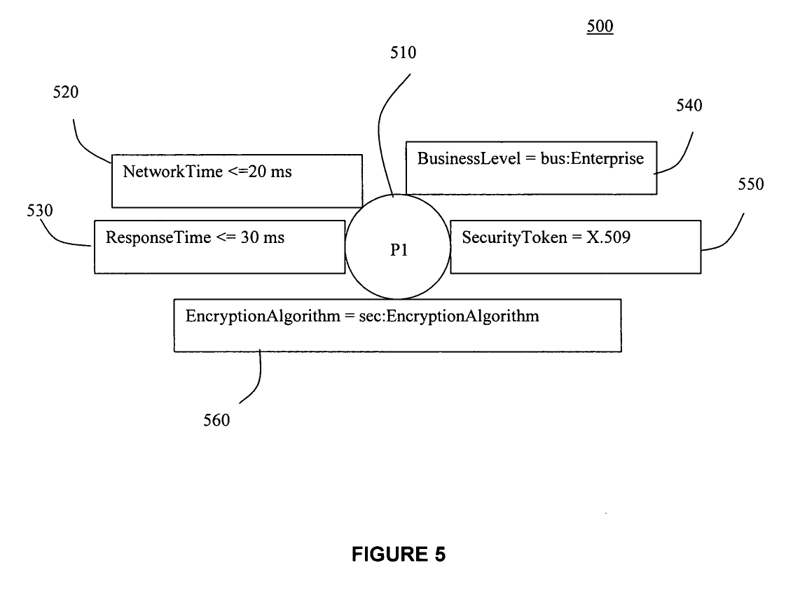

Assuming a policy P1 (e.g., 510 in FIG. 5) with the following requirements and capabilities, as shown in FIG. 5.

Requirements:

Business Level of Requestor preferably is Enterprise (e.g., 540)

Security Token preferably is X.509 (e.g., 550)

Some encryption preferably is used (e.g., 560)

Capabilities:

Network Time <=20 ms (e.g., 520)

Response Time <=30 ms (e.g., (530)

The following rule is fired when the above assertions are added to the policy object:

response Time(P)+network Time (P)=total Time (P)

Hence, a new assertion is generated

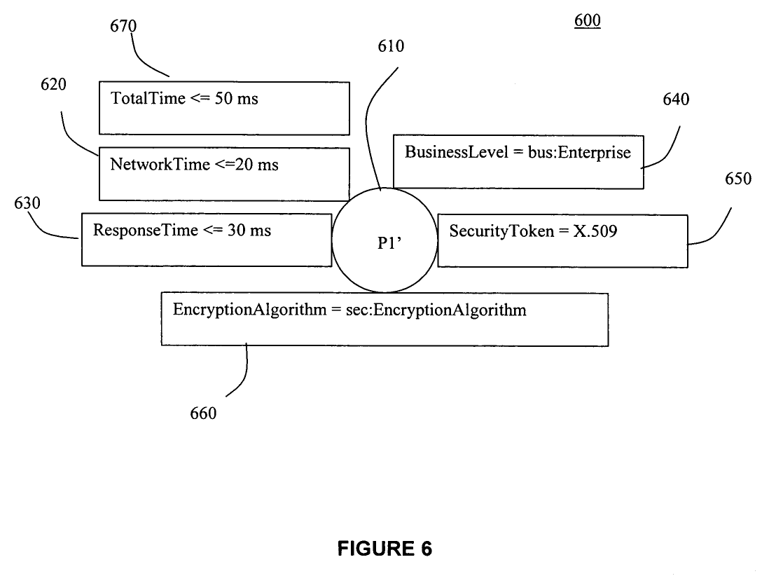

Total Time <=50 ms (e.g., 670 in FIG. 6).

Therefore, after the insertion of this new knowledge into the ontology management system, the updated policy P1′ (e.g., 610), as shown in FIG. 6 will look as follows:

Requirements:

Business Level of Requestor preferably is Enterprise (e.g., 640)

Security Token preferably is X.509 (e.g., 650)

Some encryption preferably is used (e.g., 660)

Capabilities:

Network Time <=20 ms (e.g., 620)

Response Time <=30 ms (e.g., (630)

Total Time <=50 ms (e.g., 670)

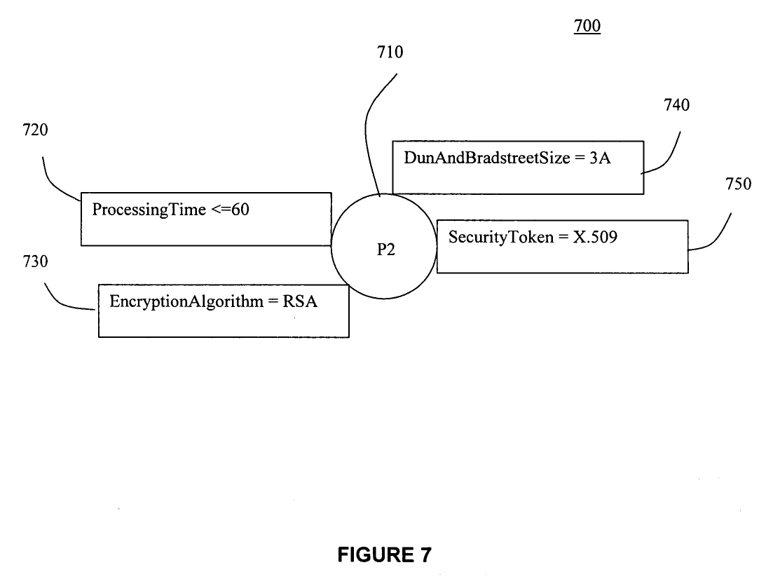

Similarly, let us also assume that we have a policy P2 (e.g., 710, as exemplarily shown in FIG. 7) with the following requirements and capabilities.

Requirements:

Processing Time <=60 sec (e.g., 720)

Security Token preferably is X.509 (e.g., 750)

Encryption Algorithm preferably is RSA (e.g., 730)

Capabilities:

DunAndBradStreetSize is 3A (e.g., 740)

The following rules are fired when the above assertions are added to the policy object.

DunAndBradStreetSize(P, 3A)=>business Level(P)=Enterprise

Therefore, a new assertion is generated

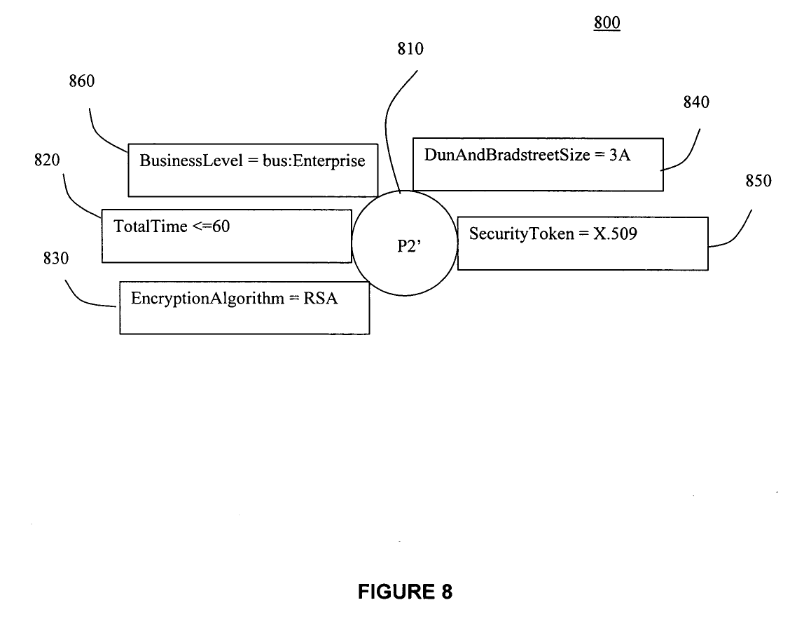

Business Level is Enterprise (e.g., 860 in FIG. 8).

With this new knowledge, the updated policy P2′ (e.g., 810), which is exemplarily shown in FIG. 8 will look as follows:

Requirements:

Business Level is Enterprise (e.g., 860)

Processing Time <=60 sec (e.g., 820)

Security Token preferably is X.509 (e.g., 850)

Encryption Algorithm preferably is RSA (e.g., 830)

Capabilities:

DunAndBradstreetSize is 3A (e.g., 840)

The exemplary matchmaking framework can now match the policies P1′ and P2′ by checking whether they satisfy each others' requirements (step 240 of FIG. 2).

Checking all requirements of policy 1:
1. Business Level (P1, Enterprise) is satisfied by assertion Business Level (P1, Enterprise) as Enterprise==Enterprise
2. SecurityToken (P1, X.509) is satisfied by assertion SecurityToken (P2, X.509) as X.509==X.509
3. EncryptionAlgorithm (P1, EncryptionAlgorithm) is satisfied by assertion EncryptionAlgorithm (P1, RSA) as RSA subClassOf EncryptionAlgorithm

Therefore, all requirements of policy 1 are satisfied by policy 2.

Checking all requirements of policy 2:

1. Processing Time (P2, <=, 60) is satisfied by assertion Total Time (P1, <=, 50) as 50<=60 and also with the assertion in the ontology that states that Processing Time and Total Time are equivalent.

Therefore, all requirements of policy 2 are satisfied by policy 1.

Since all requirements of both policies are satisfied by each other, the matcher declares these policies as being equivalent (e.g., step 250 of FIG. 2).

As mentioned above, assertions are used to represent a requirement or a behavior of Web Services in any number of domains. An assertion can have any number of child assertions and any number of attributes. The type of the assertion can be specified by using the QName (e.g., see Namespaces in XML, World Wide Web Consortium 14-Jan.-1999, http://www.w3.org/TR/REC-xml-names/) specified in a domain specific vocabulary. A sample assertion is shown below.

<wsse:SecurityToken>
<wsse:TokenType>wsse:Kerberosv5TGT</wsse:TokenType>
</wsse:SecurityToken>

This assertion is a security assertion, which is specified by the “wsse”, which is the URI part of the name of the root element of the assertion. In the WS-Policy specification, this URI is mapped the URI of the OASIS site hosting the XML schema description of WS-Security. The local part of the name of root element “SecurityToken” specifies that it is a security token assertion. It has a child assertion which states that the token type of the security token should be Kerberosv5TGT.

In order to add semantics to assertions, a schema similar to that used in Sivashanmugam, et al., Adding Semantics to Web Services Standards, The Proceedings of the First International Conference on Web Services (ICWS 2003), 2003, pp:395-401 is used. QNames can be used to represent OWL classes and properties. An assertion using ontologies is exemplarily shown below.

<semsecurity:SecurityToken
assertionType=“sempolicy:Requirement”
valueType=“owl:object”
comparisonOperator=“sempolicy:EQ”>
<semsecurity:TokenType
assertionType=“sempolicy:Requirement”
valueType=“owl:object”
comparisonOperator=“sempolicy:EQ”>semsecurity:Kerberosv5TGT
</semsecurity:TokenType>
</semsecurity:SecurityToken>

The URI part of QName “semsecurity:SecurityToken”, is mapped an URI hosting a security ontology in OWL, which has semantic description of SecurityToken, Kerberosv5TGT and TokenType. The URI part of QName “sempolicy:”, is mapped an URI hosting a policy ontology in OWL, which has semantic description of Policy, Alternative, Assertion and other elements of a policy. In addition, three optional attributes are added for each assertion.

assertionType: This attribute is used to specify whether an assertion is a requirement or a capability. The current specification states an assertion is a requirement or a capability of a Web service. As a result during matchmaking, all assertions have to be matched and are considered as both a capability and requirement. This restricts the type of assertions that can be supported by WS-Policy.

Assertions are allowed to be either a requirement or a capability. In the exemplary framework, requirement assertions are defined as being the same as the generic assertions defined in the WS-Policy framework. Hence, a requirement assertion represents both a requirement and a capability.

On the other hand, capability assertions are just additional information provided by the policy. The present invention could have created capability assertions effect by setting the required attribute to false, but in order to explicate the semantics of assertions, an exemplary aspect of the invention adds the “assertionType” attribute. By default, an assertion is a requirement assertion. The assertions shown above are requirements.

valueType: This attribute is used to specify whether an assertion is a numeric or a non-numeric assertion. The value owl:object specifies its non numeric and owl:literal specifies its numeric. The present invention uses this attribute to decide whether to use numeric reasoning or description logics-based reasoning for matching the particular assertion. By default, an assertion is a non numeric assertion.

comparisonOperator: This attribute is used to represent the relationship between the assertion name and value. For example the child assertion above states that “TokenType=Kerberosv5TGT”. WS-Policy assumes an “equals-to” relationship. While the “equals-to” is the default value we allow “greater than”, “less than”, “greater that equal to”, “less that equal to” for number numeric assertions and “subclassof”, “superclassof”, “instanceof” for non numeric assertions.

The WS-Policy standard can be used describe the non-functional behavior of Web Services. It is a domain independent language which allows users to make assertions about the services' non-functional behavior in any number of domains. In order to facilitate making assertions, XML-based vocabularies have been developed in a number of domains. For example, security assertions are based on WS-Security, transactional behavioral assertions are based on WS-Transaction and Atomic Transaction and trust assertions are based on WS-Trust and WS-Federation. Another work in this domain is by Wohlstadter et al., 2004, which extends the grammar of WS-Policy to add qualifying conditions and numerical predicates, but is still based on syntactical domain models. Having XML-based models limits the expressivity of the assertions and also limits the matching to syntactical matching.

An exemplary aspect of the present invention addresses these limitations by using OWL based domain ontologies along with ABLE rules. This allows the exemplary matcher according to the present invention to use rich domain knowledge for better matching.

Another work in the syntactical domain is by Yang et al., 2003, which addresses syntactical heterogeneity of homogeneous assertions from a mathematical point of view.

The present invention allows users to represent rules which will capture such heterogeneity for matching. In addition, the present invention can also have rules on non-numeric entities. Mukhi and Plebani, 2004 discuss issues in WS-Policy based frameworks.

One of the problems mentioned by Mukhi et al. is capturing and reasoning on inter domain dependencies between assertions of different domains. Once again, such dependencies can be captured using ontologies and rules and used in the matchmaking.

As mentioned above, the present invention is domain-independent and can handle domains like trust and privacy. In addition, the present invention is capable of incorporating numerical reasoning into the system. As mentioned above, Li and Horrocks, 2004 provides an approach for matching non functional attributes, but their framework is restricted as they rely solely on subsumption for the matching and their expressivity is limited by description logics.

While the present invention also takes care of hierarchical relationships (the basis for subsumption), it is more flexible. That is, the present invention can use subsumption-based reasoning, as well as specialized domain reasoners for the matching. In addition, the present invention can support relationships (inter and intra domain) which cannot be represented using description logics by using rules. If an alternative requires encryption using algorithm A, while at the same time requiring message compression using algorithm B, a rule can be written to invalidate the assertion.

To summarize, the exemplary aspects of the present invention provide a system and method for matching non-functional requirements of Web Services based on creating rich domain models using ontologies and rules. Thus, the present invention can provide a domain-independent approach for semantic policy matchmaking as well as an approach for implementing horn logic-based rules to be used in conjunction with OWL based ontologies.

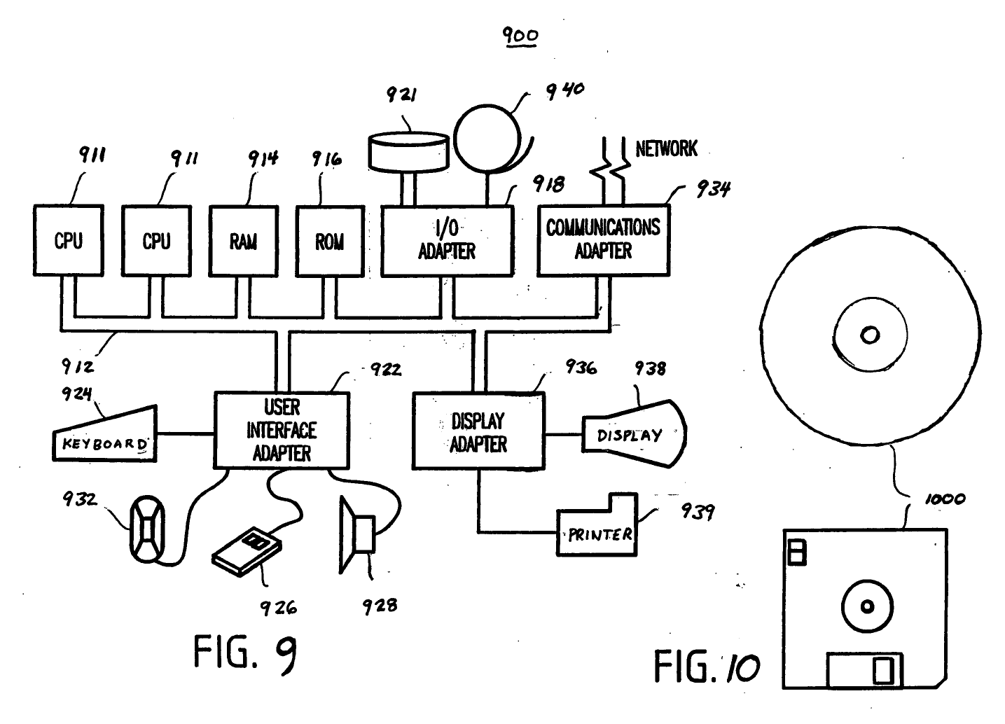

FIG. 9 illustrates a typical hardware configuration of an information handling/computer system for use with the invention and which preferably has at least one processor or central processing unit (CPU) 911.

The CPUs 911 are interconnected via a system bus 912 to a random access memory (RAM) 914, read-only memory (ROM) 916, input/output (I/O) adapter 918 (for connecting peripheral devices such as disk units 921 and tape drives 940 to the bus 912), user interface adapter 922 (for connecting a keyboard 924, mouse 926, speaker 928, microphone 932, and/or other user interface device to the bus 912), a communication adapter 934 for connecting an information handling system to a data processing network, the Internet, an Intranet, a personal area network (PAN), etc., and a display adapter 936 for connecting the bus 912 to a display device 938 and/or printer.

In addition to the hardware/software environment described above, a different aspect of the invention includes a computer-implemented method for performing the above method. As an example, this method may be implemented in the particular environment discussed above.

Such a method may be implemented, for example, by operating a computer, as embodied by a digital data processing apparatus, to execute a sequence of machine-readable instructions. These instructions may reside in various types of signal-bearing media.

This signal-bearing media may include, for example, a RAM contained within the CPU 911, as represented by the fast-access storage for example. Alternatively, the instructions may be contained in another signal-bearing media, such as a magnetic data storage or CD-ROM diskette 1000 (FIG. 10), directly or indirectly accessible by the CPU 911.

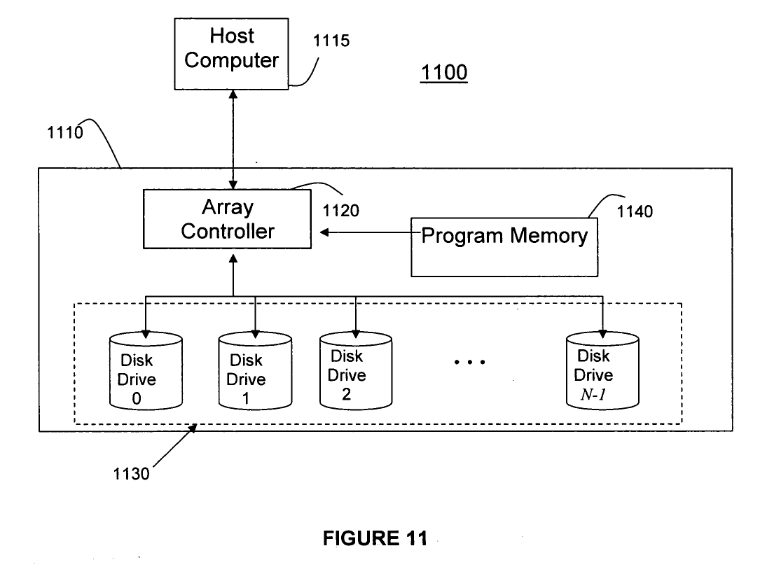

Whether contained in the diskette 1000, the computer/CPU 911, or elsewhere, the instructions may be stored on a variety of machine-readable data storage media, such as DASD storage (e.g., a conventional “hard drive” or a RAID array (e.g., 1100 in FIG. 11)), magnetic tape, electronic read-only memory (e.g., ROM, EPROM, or EEPROM), an optical storage device (e.g. CD-ROM, WORM, DVD, digital optical tape, etc.), paper “punch” cards, or other suitable signal-bearing media including transmission media such as digital and analog and communication links and wireless. The ordinarily skilled artisan would understand that a RAID array (e.g., 1100 in FIG. 11) could include a host computer 1115 connected to an array controller 1120 of a system 1110. The host computer 1115 could store data on the array controller 1120. The array controller could use a program or logic extracted from the program memory 1140 to determine redundancy values for the data according to the erasure code of the system 1110, and store the data and parity values in the disk drives 1130. If sector losses are detected by the array controller 1120 when accessing one or more of the disk drives 1130, then the array controller could call on additional program instructions from the program memory 1140 to determine recovery formulas using a combination of direct methods and sequential methods.

In an illustrative embodiment of the invention, the machine-readable instructions may comprise software object code, compiled from a language such as “C”, etc.

Additionally, in yet another aspect of the present invention, it should be readily recognized by one of ordinary skill in the art, after taking the present discussion as a whole, that the present invention can serve as a basis for a number of business or service activities. All of the potential service-related activities are intended as being covered by the present invention.

While the invention has been described in terms of several exemplary embodiments, those skilled in the art will recognize that the invention can be practiced with modification within the spirit and scope of the appended claims.

For example, the invention is not limited to any particular language (i.e., OWL) but can use any language. Additionally, the policy examples and types listed above are merely exemplary and are non-limiting.

Further, it is noted that, Applicant's intent is to encompass equivalents of all claim elements, even if amended later during prosecution.

What is claimed is:

1. A method of matching of web service policies, comprising:
matching of non-functional properties of first and second Web Services while considering inter-domain interactions of said first and second Web Services using semantics.

2. The method according to claim 1, wherein said method further comprises:
capturing at least one relationship between terms used in defining policies of Web Services.

3. The method according to claim 1, wherein said method further comprises:
representing policies by referring to at least one term in a domain model.

4. The method according to claim 1, wherein said method further comprises:
capturing at least one of an enumeration of equivalent alternatives and a relationship in a domain model.

5. The method according to claim 1, wherein said method further comprises:
applying rules represented in domain models.

6. The method according to claim 5, further comprising:
identifying inconsistencies in policies specified for said first and second Web Services.

7. The method according to claim 1, wherein said method further comprises:
capturing domain knowledge.

8. The method according to claim 7, wherein said method further comprises:
loading ontologies and rules in an ontology management system.

9. The method according to claim 8, wherein said method further comprises:
loading at least one policy into said ontology management system.

10. The method according to claim 9, wherein said method further comprises:
matching polices based on domain knowledge stored in said ontology management system.

11. The method according to claim 9, wherein said method further comprises:
matching polices based on inter-domain knowledge stored in said ontology management system.

12. The method according to claim 10, wherein said method further comprises:
outputting a working policy based on inter-domain interactions.

13. A method of matching of web service policies, comprising:
matching of non-functional properties of first and second Web Services while considering inter-domain interactions of said first and second Web Services using semantics, said matching including:
capturing domain knowledge in ontologies and rules;
loading a plurality of policies;
storing and managing captured domain knowledge;
matching policies based on said stored domain knowledge; and
outputting a working policy determined by said matching.

14. A system for matching of web service policies, comprising:
a matcher that matches non-functional properties of first and second Web Services while considering inter-domain interactions of said first and second Web Services using semantics.

15. The system according to claim 14, further comprising:
a capturing unit configured to captures domain knowledge in ontologies and rules;
a policy loader configured to load a plurality of policies;
an ontology management unit configured to manage domain knowledge captured by said capturing unit.

16. The system according to claim 14, wherein said matcher comprises a policy matcher that matches policies based on said domain knowledge stored in said ontology management unit.

17. The system according to claim 14, wherein said matcher comprises a policy matcher that matches policies based on inter-domain knowledge stored in said ontology management unit.

18. The system according to claim 14, further comprising:
an output unit configured to output a working policy determined by said matcher.

19. A method for deploying computing infrastructure in which computer-readable code is integrated into a computing system, and combines with said computing system to perform a method of matching of web service policies, said method of matching comprising:
matching of non-functional properties of first and second Web Services while considering inter-domain interactions of said first and second Web Services using semantics.

20. A signal-bearing medium tangibly embodying a program of machine-readable instructions executable by a digital processing apparatus to perform the method according to claim 1.
